(19) United States
(12) Patent Application Publication
(10) Pub. No.: US 2022/0372789 A1
(43) Pub. Date: Nov. 24, 2022

(54) HANDLE AND LOCK STRUCTURE WITH THE HANDLE

(71) Applicant: Shanghai Anviz Technology Co., Ltd., Shanghai (CN)

(72) Inventors: Chenglin Qiu, Shanghai (CN); Yongshuai Zhu, Shanghai (CN)

(21) Appl. No.: 17/512,661

(22) Filed: Oct. 27, 2021

(30) Foreign Application Priority Data
May 19, 2021 (CN) 202110546806.0

(51) Int. Cl. E05B 13/00; E05B 3/00; E05B 1/00

(52) U.S. Cl. CPC E05B 13/002; E05B 3/003; E05B 1/003

(57) ABSTRACT

This present application discloses a handle and a lock structure applying to the handle, the handle including a handle portion and a rotating shaft portion for use with the handle portion, the handle portion and the rotating shaft portion are slidably and rotatably fitted to form a snap-fit mounting structure, and the handle portion is provided with a press-on member for locking the rotating shaft portion after the snap-fit is formed; the snap-fit mounting structure includes a first snap-fit portion and a second snap-fit portion, at least two snap-fit positions are formed on the first snap-fit portion, different snap-fit positions of the snap-fit mounting structure are selected to determine a mating use state of the handle portion and the rotating shaft portion, and the rotating shaft portion is rotated, so that the second snap-fit portion is snap-fitted to a corresponding snap-fit position of the first snap-fit portion.

### CROSS-REFERENCE TO RELATED APPLICATION

The present application claims the priority benefits of China application No. 202110546806.0 filed on May 19, 2021. The entirety of the above-mentioned patent application is hereby incorporated by reference herein and made a part of this specification.

### TECHNICAL FIELD

This application relates to the technical field of locks, and more particularly, to a handle and a lock structure with the handle.

### BACKGROUND

Currently, the lock handle is classified into a left hand door handle and a right hand door handle according to the direction of opening the door. In general, a user needs to unscrew an internal fixing screw, and screw the fixing screw after changing the direction of the lock handle.

With regard to the related art described above, in the conventional method for adjusting and fixing the screw, there is a problem that the lock handle loosens or even comes off due to a long time of use or thread damage.

### SUMMARY

In order to realize the object of improving the usage stability of a handle on the basis that the direction of the handle is adjustable, the present application provides a handle.

In a first aspect, the present application provides a handle, which adopts the following technical solution.

A handle including a handle portion and a rotating shaft portion that is used cooperatively with the handle portion, wherein the handle portion and the rotating shaft portion are slidably and rotatably snap-fitted with each other to form a snap-fit mounting structure, and the handle portion is provided with a press-on member for locking the rotating shaft portion after the snap-fitting; the snap-fit mounting structure comprises a first snap-fit portion and a second snap-fit portion, at least two snap-fit positions are formed on the first snap-fit portion, a cooperative usage state of the handle portion and the rotating shaft portion depends on selecting of the snap-fit positions of the snap-fit mounting structure; the handle portion and the rotating shaft portion are relatively rotated so that the second snap-fit portion is snap-fitted to different snap-fit positions of the first snap-fit portion, and the second snap-fit portion is elastically snap-fitted to a corresponding snap-fit position of the first snap-fit portion under action of the press-on member.

By adopting the above technical solution, during changing the direction of the handle, the rotating shaft portion is rotated, so that the second snap-fit portion is snap-fitted to a corresponding snap-fit position of the first snap-fit portion. In this way, the reversal adjustment requirement of the handle is satisfied, and on this basis, the purpose of stabilizing and locking the rotating shaft portion and the handle portion is achieved by snap-fitting the structure of the first snap-fit portion and the second snap-fit portion in combination with a press-on locking manner. Thus, the usage stability of the handle is improved, and the problem of loosening or falling out that a conventional handle tends to occur is solved.

In some embodiments, the first snap-fit portion is configured to have a ring-shaped structure, and a notch, through which the second snap-fit portion passes, is formed on the first snap-fit portion, and a snap-fit groove is formed on the first snap-fit portion as a snap-fit position, and the second snap-fit portion slides on the first snap-fit portion to snap-fit into a corresponding snap-fit groove.

By adopting the above technical solution, the second snap-fit portion forms a snap-fitting structure with the snap-fit position in the first snap-fit portion via the notch. The first snap-fit portion is designed as the ring-shaped structure, so that the second snap-fit portion can slide on the first snap-fit portion when selecting corresponding snap-fit position, and good operability is achieved.

In some embodiments, the first snap-fit portion extends to form a limiting snap-fit portion; the second snap-fit portion comprises a first snap-fit block which slides on the first snap-fit portion to snap-fit to the snap-fit groove, and a second snap-fit block which abuts against and limit-fits with the limiting snap-fit portion; the snap-fit groove comprises a boundary groove communicating with the notch; and when the first snap-fit block snap-fits into the boundary groove, the second snap-fit block abuts against the limiting snap-fit portion so that the first snap-fit block snap-fits to the boundary groove.

By adopting the above technical solution, the limiting snap-fit portion and the second snap-fit block of the second snap-fit portion form a limiting snap-fit, when the first snap-fit block is snap-fitted into the boundary groove, the second snap-fit block plays a role in limiting the first snap-fit block from escaping from the boundary groove via the notch, to obtain a stable snap fit while not affecting the quick snap fit of the first snap-fit block with the boundary groove, thereby facilitating to improve the sliding smoothness of the first snap-fit block along the first snap-fit portion and the snap-fitting convenience of the first snap-fit block and the boundary groove.

In some embodiments, the number of the snap-fit grooves is set to two, an intermediate groove is formed between the two snap-fit grooves, and the two snap-fit grooves are respectively formed at positions of 0 degree and 180 degree in a circumferential direction of the first snap-fit portion, and the intermediate groove is formed at a position of 90 degree in the circumferential direction of the first snap-fit portion.

By adopting the above technical solution, the positions of the two snap-fit grooves are further limited to meet the requirement for left-right reversing of the handle, meanwhile, a 90-degree transition position is added between the two snap-fit positions, when the door with a handle is transported, the handle can be rotated to the 90-degree position, so as to facilitate binding of the door and the handle.

In some embodiments, a curved section is formed on the first snap-fit portion at a transition position between the snap-fit groove and the intermediate groove.

By adopting the above technical solution, the curved section is arranged so that the sliding smoothness of the first snap-fit block in the two snap-fit grooves and the intermediate groove.

In some embodiments, a disengagement interval is formed on the handle portion or the rotating shaft portion for separating the second snap-fit block from the limiting snap-fit portion, and a sliding interval is correspondingly formed on the handle portion or the rotating shaft portion for sliding the first snap-fit block in a direction of disengagement movement.

By adopting the above technical solution, the disengagement interval and the sliding interval are arranged, one is to better meet the reversing demand of the handle, the other one is to achieve detachable separation of the rotating shaft portion and the handle portion, so as to facilitate later maintenance or replacement operations.

In some embodiments, the press-on member is provided as an elastic member, and both ends of the elastic member form a positioning and insertion fit with a corresponding handle or rotating shaft portion.

By adopting the above technical solution, the fixing of the elastic member is completed by means of positioning and insertion fitting, which is beneficial to improve the stability of the press-on action and further improve the stability of the handle during normal use and reversal operations.

In some embodiments, an inserting hole is formed on the handle portion and/or the rotating shaft portion, a positioning block is provided in the inserting hole, and the elastic member is sleeved on the positioning block.

By adopting the above technical solution, a positioning block is introduced, so as to further improve the stability of the elastic member when installed and used.

In a second aspect, the present application provides a lock structure, which is applied with the handle, adopting the following technical solution.

A lock structure with a handle, including a lock cylinder and a connecting portion for connecting the handle with the lock cylinder, wherein the connecting portion is rotatably mounted to a door panel, an inserting end is formed on the rotating shaft portion, the inserting end forms a positioning and insertion fit with the connecting portion, a threaded mounting hole is provided in the inserting end, and the connecting portion is provided with a locking member which is threadedly connected to the threaded mounting hole.

By adopting the above technical solution, the inserting end forms a positioning and insertion fit with the connecting portion, and then the connecting portion is locked with the handle by the locking member, so as to achieve an accurate assembly and stable connection between the handle and the door.

### BRIEF DESCRIPTION OF THE DRAWINGS

FIG. 1 is a schematic diagram of a handle assembly according to an embodiment 1 of the present application;

FIG. 2 is a schematic structural diagram of a handle portion according to the embodiment 1 of the present application;

FIG. 3 is a schematic diagram showing a back side structure in a direction of a notch of a rotating shaft portion according to the embodiment 1 of the present application;

FIG. 4 is a schematic diagram showing a front side structure in a direction of a limiting snap-fit portion of a rotating shaft portion according to the embodiment 1 of the present application;

FIG. 5 is a schematic diagram showing a front side structure in a direction of a notch of a rotating shaft portion according to the embodiment 1 of the present application;

FIG. 6 is a schematic diagram of a handle assembly in an embodiment 2 of the present application;

FIG. 7 is a schematic structural diagram of a handle portion according to the embodiment 2 of the present application; and

FIG. 8 is a schematic diagram showing an overall structure of a lock structure according to an embodiment of the present application.

### DESCRIPTION OF THE EMBODIMENTS

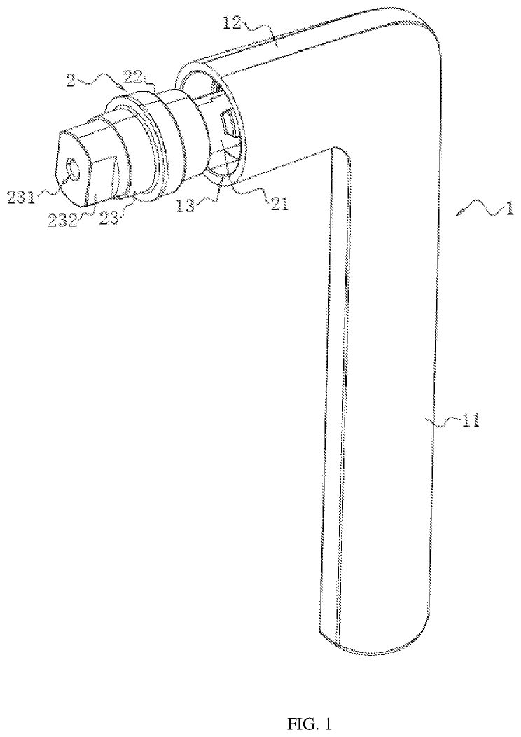

The present application is described in further detail below with reference to FIGS. 1-8.

Embodiments of the present application provide a handle.

### Embodiment 1

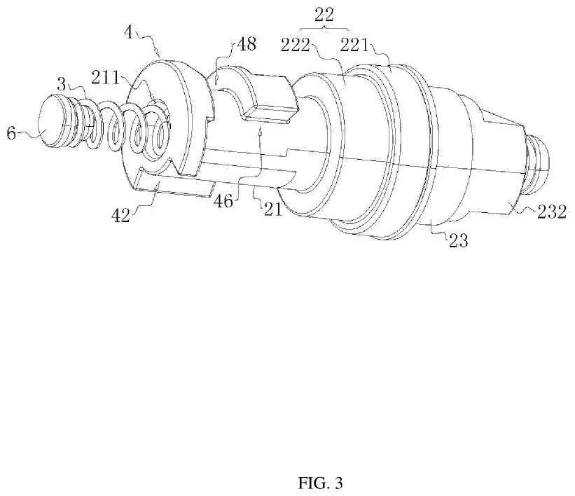

Referring to FIGS. 1 and 3, a handle includes a handle portion 1 and a rotating shaft portion 2, which are used cooperatively. The rotating shaft portion 2 is inserted into the handle portion 1. The handle portion 1 and the rotating shaft portion 2 are integrated as a whole by means of a snap-fit mounting structure, and are locked with each other by means of a press-on member 3 mounted inside the handle portion 1. In this way, instead of a conventional screw locking manner, a snap-fitting structure and a press-on locking are cooperated, so as to improve the usage stability of the handle.

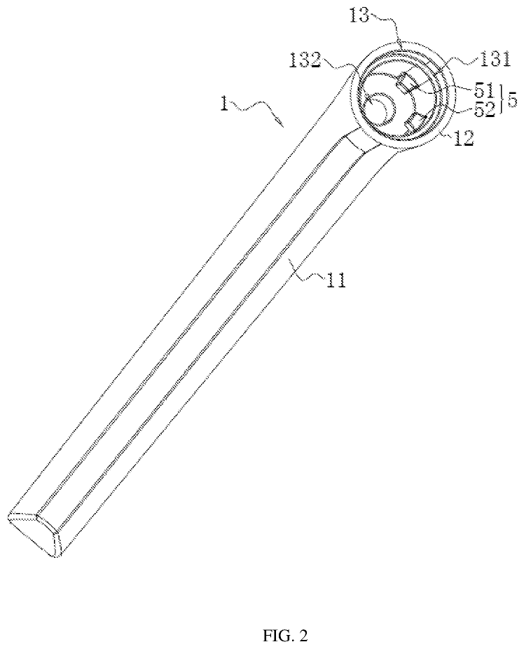

Referring to FIGS. 1 and 2, in this embodiment, the handle portion 1 is configured with an L-shaped structure, which includes a long side 11 having a flat shape and a short side 12 that is integrated with any end of the long side 11 and is formed by bending. The short side 12 is perpendicular to the long side 11, and one end of the short side 12 is integrally formed with the long side 11. The other end of the short side 12 is coaxially provided with an assembly mounting hole 13. The rotating shaft portion 2 is coaxially inserted into the assembly mounting hole 13 and integrated with the short side 12 as a whole by means of a snap-fit mounting structure.

Referring to FIG. 3, the rotating shaft portion 2 includes a front section 21, an intermediate section 22 and a rear section 23 which are integrally formed in sequence, and all of which have a coaxially arranged cylindrical structure. The front section 21 is mainly configured for a snap-fitting with the assembly mounting hole 13 by means of the snap-fit mounting structure. The intermediate section 22 includes a first section 221 and a second section 222, both of which have a diameter greater than that of the front section 21. The diameter of the first section 221 is greater than that of the second section 222. The second section 222 is coaxially formed with a shaft end of the front section 21. Correspondingly, a stepped groove 131 is formed on an inner wall of an orifice of the assembly mounting hole 13. When the rotating shaft portion 2 is inserted into the assembly mounting hole 13, a stepped limiting structure formed by the first section 221 and the second section 222 may be fitted with the stepped groove 131, thereby achieving a purpose of limiting the insertion depth of the rotating shaft portion 2. The diameter of the rear section 23 is larger than the diameter of the front section 21, but slightly smaller than the diameter of the second section 222, so as to lock and connect with a lock for using with the handle.

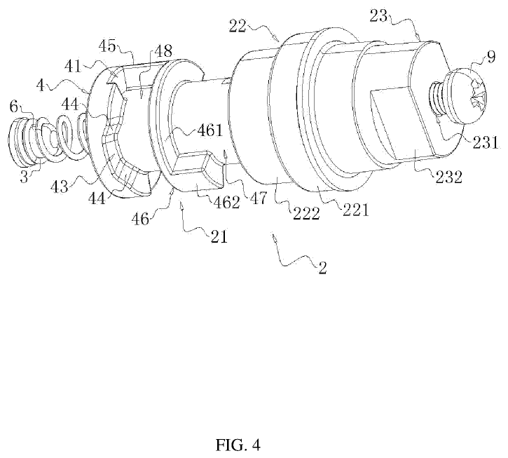

Referring to FIGS. 3 and 4, the snap-fit mounting structure includes a first snap-fit portion 4 integrally formed on the rotating shaft portion 2, and a second snap-fit portion 5 integrally formed on a hole wall of the mounting hole. The first snap-fit portion 4 has a ring-shaped structure integrally formed along the periphery of a shaft end of the front section 21 that is away from the intermediate section 22. Two snap-fit positions are formed on the first snap-fit portion 4. In the embodiment of the present application, the snap-fit position is a snap-fit groove 41 that is formed on an inner side surface of a ring-shaped structure, and the snap-fit groove 41 is a rectangular groove. The second snap-fit portion 5 includes a first snap-fit block 51 which forms a snap-fitting with two snap-fit positions of the first snap-fit portion 4. A notch 42 is provided on the first snap-fit portion 4. When the rotating shaft portion 2 is inserted into the assembly mounting hole 13, the first snap-fit block 51 may penetrate through the first snap-fit portion 4 via the notch 42. During the rotation of the rotating shaft portion 2, the snap-fitting with any of the snap-fit positions can be realized.

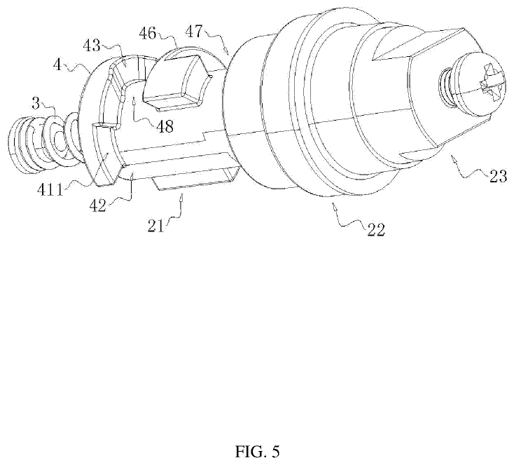

Referring to FIGS. 4 and 5, the number of snap-fit grooves 41 is set to two, and an intermediate groove 43 is formed at a position in the middle of the two snap-fit grooves 41 on the first snap-fit portion 4. The two snap-fit grooves 41 are positioned at two opposite ends in a diameter direction of the front section 21. In other words, the two snap-fit grooves 41 are respectively formed at positions of 0 degree and 180 degree in a circumferential direction of the front section 21, and the intermediate groove 43 is formed at a position of 90 degree in the circumferential direction of the front section 21. According to actual requirements, the user may select two snap-fit grooves 41 at the position of 0 degree or 180 degrees to be used cooperatively with the first snap-fit block 51, so as to achieve the purpose of adaptively adjusting of the handle mounting position. The snap-fit groove 41 at the position of 90 degree is an intermediate transition position. Generally, when a door with the handle according to the embodiment is transported, the snap-fit groove 41 at the position of 90 degree is selected to be used cooperatively with the first snap-fit block 51, so that the handle is arranged along the height direction of the door, thereby facilitating binding and fixing of the handle and the door.

Referring to FIG. 4, on the basis of the above embodiment, a curved section 44 is formed at a transition position between the intermediate groove 43 and the snap-fit grooves 41 on both sides of the first snap-fit portion 4. The first snap-fit block 51 can smoothly rotate through the curved section 44 and the intermediate groove 43 during the rotating of the rotating shaft portion 2.

Referring to FIGS. 4 and 5, one end of the first snap-fit portion 4 at the position of the notch 42 extends in the axial direction of the front section 21 to integrally form a transition portion 45. The transition portion 45 further extends to integrally form a limiting snap-fit portion 46. The limiting snap-fit portion 46 includes a ring plate 461 that is integrally formed by extending in the circumferential direction of the front section 21. An end of the ring plate 461 away from the transition portion 45 extends in the axial direction of the front section 21 to integrally form a stopper 462. A snap-fit groove 41 is formed at the other end of the first snap-fit portion 4 at a position of the notch 42, and the snap-fit groove 41 is used as a boundary groove 411. The boundary groove 411 is directly communicated with the notch 42. The other snap-fit groove 41 is formed at a corner position where the first snap-fit portion 4 is connected with the transition portion 45. Referring to FIG. 2, in addition to the first snap-fit block 51 described above, the second snap-fit portion 5 further includes a second snap-fit block 52 that is also formed on the inner wall of the assembly mounting hole 13. The second snap-fit block 52 and the first snap-fit block 51 are arranged in a front-rear misalignment manner on the inner wall of the assembly mounting hole 13, an included angle of which in the circumferential direction of the assembly mounting hole 13 is set to 90 degree. With reference to FIGS. 2 and 4, when the rotating shaft portion 2 is inserted into the assembly mounting hole 13 of the handle portion 1, the first snap-fit block 51 snap-fits with a corresponding snap-fit groove 41, and the second snap-fit block 52 abuts against an outer side surface of the ring plate 461. When the first snap-fit block 51 snap-fits with the boundary groove 411, the second snap-fit block 52 slides along the outer side surface of the ring plate 461 and is snap-fitted at a position where the ring plate 461 and the stopper 462 are connected, thereby preventing the first snap-fit block 51 from escaping from the boundary groove 411 on the basis that the first snap-fit block 51 can quickly snap-fits with the boundary groove 411, and obtaining a more stable snap-fitting. Further, the handle mounting direction is quickly and conveniently adjusted and the purpose of stabilizing the snap-fitting structure is achieved.

With reference to FIGS. 2 and 4, a disengagement interval 47 is formed on a cylindrical surface of the front section 21, which is positioned between the second section 222 and the stopper 462. A sliding interval 48 is formed between the outer side surface of the ring plate 461 and the inner side surface of the first snap-fit portion 4. When the rotating shaft portion 2 needs to be disassembled, the user may rotate the rotating shaft portion 2 such that the boundary groove 411 snap-fits with the first snap-fit block 51, press the rear section 23 of the rotating shaft portion 2 to overcome the press-on acting force of the press-on member so that the second snap-fit block 52 disengages the limiting snap-fit portion 46 and slides along the axial direction of the front section 21 into the disengagement interval 47, i.e., the second snap-fit block 52 abutting against a side edge of the second section 222. Meanwhile, the first snap-fit block 51 is disengaged from a corresponding snap-fit position and slides along the axial direction of the front section 21 into the sliding interval 48, i.e., the first snap-fit block 51 abutting against the outer side surface of the ring plate 461. Then, the user rotates the rotating shaft portion 2 until the first snap-fit block 51 is in butt joint with the notch 42. At this time, the rotating shaft portion 2 can be pulled out in a direction opposite to the pressing direction, and the first snap-fit block 51 can be disengaged from the notch 42. When the second snap-fit block 52 is disengaged, it is required to rotate the rotating shaft portion 2 by an appropriate angle, so that the second snap-fit block 52 is in butt joint with the notch 42 and is disengaged from the notch 42, thereby completing the disassembling operation of the rotating shaft portion 2.

Referring to FIGS. 2 and 4, when changing the direction of the handle, different with the disassembling operation of the rotating shaft portion 2, it is only required to press the rear section 23 of the rotating shaft portion 2 to separate the first snap-fit block 51 from a corresponding snap-fit groove 41. At this time, the first snap-fit block 51 enters into the sliding interval 48; however, the second snap-fit block 52 does not completely enter into the disengagement interval 47. As a result, the stopper 462 can still function to restrict the first snap-fit block 51 from being disengaged form the first snap-fit portion 4. The user rotates the rotating shaft portion 2 until the first snap-fit block 51 rotates to a position where it is in butt joint with another snap-fit position, and then releases the rotating shaft portion 2 such that the press-on member 3 presses on the rotating shaft portion 2 again and the first snap-fit block 51 snap-fits another snap-fit position. Thus, the reversing operation of the handle is completed.

With reference to FIGS. 2 and 4, on the basis of the above embodiment, an elastic member is used as the press-on member 3. In this embodiment, a spring is used as the press-on member 3, and the spring is sandwiched between an inner end of the assembly mounting hole 13 and a shaft end of the front section 21. When the first snap-fit block 51 snap-fits with any one of snap-fit positions, the spring can press the shaft end of the front section 21 toward the direction in which the rotating shaft portion 2 is disengaged from the assembly mounting hole 13, so that the rectangular groove and the first snap-fit block 51 form a stable snap-fit locking.

With reference to FIGS. 2 and 3, a positioning hole 211 is coaxially formed on an end surface of the front section 21, and correspondingly, an inserting hole 132 is formed on an inner end of the assembly mounting hole 13. An end of the spring and the corresponding positioning hole 211 or inserting hole 132 form a positioning and plug-in fitting. A positioning block 6 may be embedded in the positioning hole 211 or the inserting hole 132. The positioning block 6 can be fitted to the end of the spring in a sleeving manner, thereby achieving the purpose of stably mounting the spring and obtaining a relatively stable press-on force.

The operation principle of embodiment 1 will be described below.

When the assembling operation is performed, a user aligns the notch 42 and the second snap-fit block 52 on the rotating shaft portion 2, and rotates the rotating shaft portion 2 by an angle after the second snap-fit block 52 passes through the notch 42 so that the first snap-fit block 51 passes through the notch 42, and then rotates the rotating shaft portion 2 so that the first snap-fit block 51 rotates into the sliding interval 48 until the first snap-fit block 51 is in butt joint with a corresponding snap-fit groove 41; at this time, releases the rotating shaft portion 2 such that the rotating shaft portion 2 moves towards a direction to be separated from the assembly mounting hole 13 under the action of the press-on member 3 until the first snap-fit block 51 snap-fits with a corresponding snap-fit groove 41 and the second snap-fit block 52 abuts against the ring plate 461 or is snap-fitted to a position where the ring plate 461 and the stopper 462 are formed.

When the disassembling operation is performed, the user presses the rear section 23 of the rotating shaft portion 2 in order to overcome the pressing force of the press-on member 3 so that the second snap-fit block 52 is disengaged from the limiting snap-fit portion 46 and slides along the axial direction of the front section 21 into the disengaging interval 47, and at the same time, the first snap-fit block 51 is disengaged from a corresponding snap-fit position and slides along the axial direction of the front section 21 into the disengagement interval 48. Then, the user rotates the rotating shaft portion 2 until the first snap-fit block 51 is in butt joint with the notch 42. At the same time, the rotating shaft portion 2 can be pulled out in the direction opposite to the pressing direction. The first snap-fit block 51 can be disengaged from the notch 42. When the second snap-fit block 52 is disengaged, it is required to rotate the rotating shaft portion 2 by an appropriate angle, so that the second snap-fit block 52 is in butt joint with the notch 42 and disengaged from the notch 42, thereby completing the disassembling operation of the rotating shaft portion 2.

When changing the direction of the handle, the rear section 23 of the rotating shaft portion 2 is pressed, so that the first snap-fit block 51 is separated from the corresponding snap-fit groove 41. At this time, the first snap-fit block 51 enters into the sliding interval 48, and however, the second snap-fit block 52 does not completely enter into the disengagement interval 47. As a result, the stopper 462 can still function to restrict the first snap-fit block 51 from being disengaged from the first snap-fit portion 4. The user rotates the rotating shaft portion 2 until the first snap-fit block 51 rotates to a position where it is in butt joint with another snap-fit position. Then, the rotating shaft portion 2 is released, and the press-on member 3 presses on the rotating shaft portion 2 again such that the first snap-fit block 51 snap-fits with another snap-fit position. In this way, the direction of the handle is changed.

### Embodiment 2

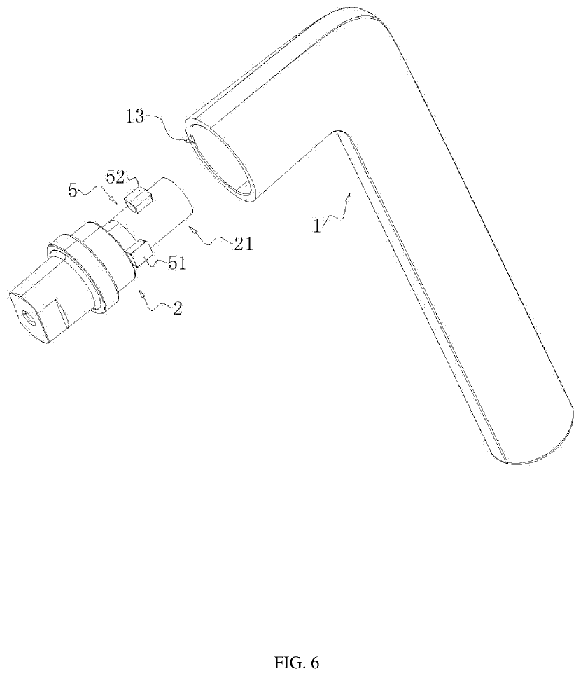

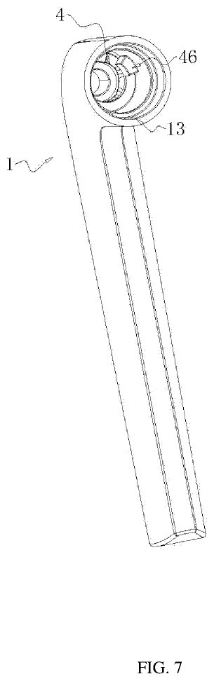

With reference to FIGS. 6 and 7, a handle differs from Embodiment 1 in that, the first snap-fit portion 4 and the second snap-fit portion 5 are formed at different positions. In this embodiment, the first snap-fit portion 4 is formed on the inner wall of the assembly mounting hole 13 of the handle portion 1, while the second snap-fit portion 5 is formed on the cylindrical surface of the front section 21 of the rotating shaft portion 2.

An embodiment of the present application further provides a lock structure with a handle as described above.

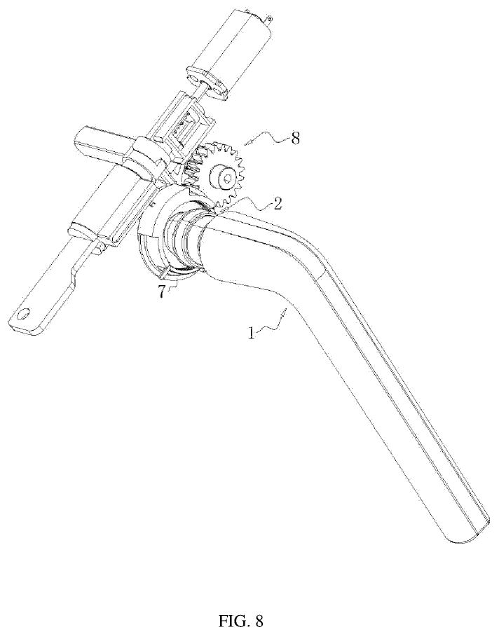

With reference to FIGS. 1 and 8, a lock structure includes a lock cylinder 8 that is operated in conjunction with the described handle via a connecting portion 7. The connecting portion 7 has a disc-shaped structure, and is rotatably mounted on a door panel. The connecting portion 7 is in locking connection with the rotating shaft portion 2 of the handle via a locking member 9. A screw is used as the locking member 9. Correspondingly, the rear section 23 of the rotating shaft portion 2 is provided with an inserting end 232, the shaft end of the inserting end 232 is coaxially provided with a threaded mounting hole 231, and the locking member 9 is inserted into the connecting portion 7 and then forms threaded connection and locking with the threaded mounting hole 231. On this basis, the inserting end 232 has a square structure, and forms a positioning and insertion fit with the connecting portion 7, so as to improve the accuracy of connecting when the connecting portion 7 and the handle are mounted.

The above description is only preferred embodiments of the present application and is not intended to limit the protection scope of the present application. Therefore, all equivalent changes of the structure, shape or principle according to the spirit of the present application should be all included in the protection scope of the present application.

### LIST OF REFERENCE NUMBER

1: handle portion; 11: long side; 12: short side; 13: assembly mounting hole; 131: stepped groove; 132: inserting hole; 2: rotating shaft portion; 21: front section; 211: positioning hole; 22: intermediate section; 221: first section; 222: second section; 23: rear section; 231: threaded mounting hole; 232: inserting end; 3: press-on member; 4: first snap-fit portion; 41: snap-fit groove; 411: boundary groove; 42: notch; 43: intermediate groove; 44: curved section; 45: transition portion; 46: limiting snap-fit portion; 461: ring plate; 462: stopper; 47: disengagement interval; 48: sliding interval; 5: second snap-fit portion; 51: first snap-fit block; 52: second snap-fit block; 6: positioning block; 7: connecting portion; 8: lock cylinder; 9: locking member.

What is claimed is:

1. A handle, comprising a handle portion and a rotating shaft portion that is used cooperatively with the handle portion, wherein the handle portion and the rotating shaft portion are slidably and rotatably snap-fitted with each other to form a snap-fit mounting structure, and the handle portion is provided with a press-on member for locking the rotating shaft portion after the snap-fitting; the snap-fit mounting structure comprises a first snap-fit portion and a second snap-fit portion, at least two snap-fit positions are formed on the first snap-fit portion, a cooperative usage state of the handle portion and the rotating shaft portion depends on selecting of the snap-fit positions of the snap-fit mounting structure; the handle portion and the rotating shaft portion are relatively rotated so that the second snap-fit portion is snap-fitted to different snap-fit positions of the first snap-fit portion, and the second snap-fit portion is elastically snap-fitted to a corresponding snap-fit position of the first snap-fit portion under action of the press-on member.

2. The handle according to claim 1, wherein the first snap-fit portion is configured to have a ring-shaped structure, and a notch, through which the second snap-fit portion passes, is formed on the first snap-fit portion, and a snap-fit groove is formed on the first snap-fit portion as a snap-fit position, and the second snap-fit portion slides on the first snap-fit portion to snap-fit into a corresponding snap-fit groove.

3. The handle according to claim 2, wherein the first snap-fit portion extends to form a limiting snap-fit portion; the second snap-fit portion comprises a first snap-fit block which slides on the first snap-fit portion to snap-fit to the snap-fit groove, and a second snap-fit block which abuts against and limit-fits with the limiting snap-fit portion; the snap-fit groove comprises a boundary groove communicating with the notch; and when the first snap-fit block snap-fits into the boundary groove, the second snap-fit block abuts against the limiting snap-fit portion so that the first snap-fit block snap-fits to the boundary groove.

4. The handle according to claim 3, wherein the number of the snap-fit grooves is set to two, an intermediate groove is formed between the two snap-fit grooves, and the two snap-fit grooves are respectively formed at positions of 0 degree and 180 degree in a circumferential direction of the first snap-fit portion, and the intermediate groove is formed at a position of 90 degree in the circumferential direction of the first snap-fit portion.

5. The handle according to claim 4, wherein a curved section is formed on the first snap-fit portion at a transition position between the snap-fit groove and the intermediate groove.

6. The handle according to claim 3, wherein a disengagement interval is formed on the handle portion or the rotating shaft portion for separating the second snap-fit block from the limiting snap-fit portion, and a sliding interval is correspondingly formed on the handle portion or the rotating shaft portion for sliding the first snap-fit block in a direction of disengagement movement.

7. The handle according to claim 1, wherein the press-on member is provided as an elastic member, and both ends of the elastic member form a positioning and insertion fit with a corresponding handle or rotating shaft portion.

8. The handle according to claim 7, wherein an inserting hole is formed on the handle portion and/or the rotating shaft portion, a positioning block is provided in the inserting hole, and the elastic member is sleeved on the positioning block.

9. A lock structure, which is applied with the handle according to claim 1, comprising a lock cylinder and a connecting portion for connecting the handle with the lock cylinder, wherein the connecting portion is rotatably mounted to a door panel, an inserting end is formed on the rotating shaft portion, the inserting end forms a positioning and insertion fit with the connecting portion, a threaded mounting hole is provided in the inserting end, and the connecting portion is provided with a locking member which is threadedly connected to the threaded mounting hole.
